(19) United States
(12) Patent Application Publication
(10) Pub. No.: US 2024/0287311 A1
(43) Pub. Date: Aug. 29, 2024

(54) QUINACRIDONE SOLID SOLUTION PIGMENT, PIGMENT DISPERSION, METHOD OF PRODUCING QUINACRIDONE SOLID SOLUTION PIGMENT, METHOD OF PRODUCING PIGMENT DISPERSION, AND INK

(71) Applicant: CANON KABUSHIKI KAISHA, Tokyo (JP)

(72) Inventors: KOUICHIROU OKUMURA, Kanagawa (JP); TSUYOSHI KASAI, Tokyo (JP); TAKUJI MUKAI, Tokyo (JP); SHIN-ICHI HAKAMADA, Kanagawa (JP); RYOSUKE NAGAO, Kanagawa (JP); RYUYA HIRAOKA, Kanagawa (JP); TARO ENDO, Kanagawa (JP)

(21) Appl. No.: 18/588,807

(22) Filed: Feb. 27, 2024

(30) Foreign Application Priority Data
Feb. 27, 2023 (JP) 2023-028412
Feb. 27, 2023 (JP) 2023-028413
Feb. 22, 2024 (JP) 2024-025583

(51) Int. Cl. C09B 48/00; B01F 23/60; B01F 101/30; C09B 67/20; C09D 11/322

(52) U.S. Cl. CPC C09B 48/00; B01F 23/60; C09B 67/0069; C09D 11/322; B01F 2101/30

(57) ABSTRACT

Provided is a quinacridone solid solution pigment that develops a color more clearly than a conventional pigment does. The quinacridone solid solution pigment includes at least two kinds of quinacridone-based pigments including unsubstituted quinacridone and 2,9-dialkylquinacridone. When a diffraction peak intensity at a diffraction angle 2θ of 5.9°±0.2° and a diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.

### BACKGROUND OF THE INVENTION

### Field of the Invention

The present invention relates to a quinacridone solid solution pigment, a pigment dispersion, a method of producing a quinacridone solid solution pigment, a method of producing a pigment dispersion, and an ink.

### Description of the Related Art

An inkjet recording method has been utilized in the recording of a business document using plain paper or the like as a recording medium, or of a photographic image using glossy paper or the like as a recording medium. In recent years, it has started to become mainstream to use a pigment as a coloring material to be used in recording by an inkjet recording method.

A quinacridone-based pigment such as C.I. Pigment Red 122 has heretofore been generally used as a magenta pigment. Meanwhile, in recent years, the use of a quinacridone solid solution pigment (also referred to as “quinacridone mixed crystal pigment”) superior in color developability to the above-mentioned quinacridone-based pigment has been proposed (see, for example, Japanese Patent Application Laid-Open No. 2000-281930, Japanese Patent Application Laid-Open No. 2013-528668, and International Publication No. WO2019/202939). Along with the foregoing, a method of producing a quinacridone solid solution pigment has also been proposed (see, for example, Japanese Patent Application Laid-Open No. 2000-38521).

In addition, in a coloring material using a pigment, a miniaturized pigment may be used from the viewpoint of an improvement in color developability. Many methods for pigment miniaturization are reported, and in the reports, for example, a salt milling method is proposed which includes: mixing a pigment, a salt serving as an abrasive, and an organic solvent; and then kneading the mixture while applying a load to compress the mixture (see, for example, Japanese Patent Application Laid-Open No. 2003-089756).

### SUMMARY OF THE INVENTION

The present invention is directed to provide a quinacridone solid solution pigment that develops a color more clearly than a conventional pigment does, and a pigment dispersion and an ink each using the quinacridone solid solution pigment. In addition, the present invention is directed to provide a method of producing a quinacridone solid solution pigment for the production of a quinacridone solid solution pigment that develops a color more clearly than a conventional pigment does, and a method of producing a pigment dispersion including using the method of producing a quinacridone solid solution pigment.

That is, according to one aspect of the present invention, there is provided a quinacridone solid solution pigment including at least two kinds of quinacridone-based pigments including unsubstituted quinacridone and 2,9-dialkylquinacridone, wherein when a diffraction peak intensity at a diffraction angle 2θ of 5.9°±0.2° and a diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.

In addition, according to another aspect of the present invention, there is provided a pigment dispersion including: a dispersion medium; and a pigment dispersed in the dispersion medium, wherein the pigment is the above-mentioned quinacridone solid solution pigment.

In addition, according to another aspect of the present invention, there is provided a method of producing a quinacridone solid solution pigment including a kneading step of kneading a mixture containing at least two kinds of quinacridone-based pigments including unsubstituted quinacridone and 2,9-dialkylquinacridone, a water-soluble inorganic salt, and a water-soluble organic solvent with a kneading apparatus to provide a pigment-kneaded product containing the quinacridone solid solution pigment, wherein the kneading step includes kneading the mixture with a kneading energy of 15 kWh/kg or more per unit mass (kg) of the quinacridone-based pigments.

In addition, according to another aspect of the present invention, there is provided a method of producing a pigment dispersion including a dispersing step of dispersing the quinacridone solid solution pigment in a dispersion medium after removing the water-soluble inorganic salt and the water-soluble organic solvent from the pigment-kneaded product obtained by the above-mentioned method of producing a quinacridone solid solution pigment.

In addition, according to another aspect of the present invention, there is provided an ink including the above-mentioned quinacridone solid solution pigment.

Further features of the present invention will become apparent from the following description of exemplary embodiments.

### DESCRIPTION OF THE EMBODIMENTS

It has been found that a hue and color developability of a quinacridone solid solution pigment largely change not only by constituents of the quinacridone solid solution pigment but also by a crystal structure of the quinacridone solid solution pigment. However, sufficient expression of the color developability of the quinacridone solid solution pigment has not been achieved because a relationship between the hue and color developability of the quinacridone solid solution pigment, and the crystal structure thereof has not been elucidated yet. Accordingly, the improvement of the quinacridone solid solution pigment has still been desired.

Accordingly, the inventors of the present invention have made extensive investigations on a quinacridone solid solution pigment, a pigment dispersion, and an ink each of which develops a color more clearly than a conventional product does, a method of producing the quinacridone solid solution pigment, and a method of producing the pigment dispersion. Thus, the inventors have reached the present invention.

The present invention is described in more detail below by way of exemplary embodiments. In the present invention, when a compound is a salt, the salt is present as dissociated ions in an ink, but the expression “contain a salt” is used for convenience. In addition, an aqueous inkjet ink is sometimes referred to simply as “ink”. Physical property values are values at normal temperature (25° C.), unless otherwise stated.

The inventors of the present invention have made an investigation with a view to obtaining a quinacridone solid solution pigment that develops a color more clearly than a conventional pigment does through use of the following two kinds of quinacridone-based pigments: unsubstituted quinacridone and 2,9-dialkylquinacridone.

The term “solid solution” as used herein refers to a crystal body in which a plurality of different molecules are present in a mixed condition of being dissolved in each other and in a uniform solid phase state, and does not refer to a simple mixture of a plurality of different compounds. Accordingly, the quinacridone solid solution pigment is expected to show color developability that is more excellent than that of a mixture obtained by merely causing two or more kinds of quinacridone-based pigments to coexist.

In addition, the crystal structure of the quinacridone solid solution pigment can be identified by X-ray diffractometry (also referred to as “X-ray crystal structure analysis”) utilizing a phenomenon in which an X-ray occurs diffraction in a crystal lattice.

A peak position in the X-ray diffraction pattern of a quinacridone solid solution pigment has a characteristic value in accordance with the kind and crystal condition of the pigment. The kind and condition of the pigment can be identified by the X-ray diffractometry through utilization of the characteristic value. Specifically, a quinacridone solid solution pigment formed of two kinds of quinacridone-based pigments, that is, a quinacridone pigment (A) and a quinacridone pigment (B) can be identified because the quinacridone solid solution pigment shows an X-ray diffraction pattern different from all of the following (1) to (3):
(1) an X-ray diffraction pattern of the quinacridone pigment (A);
(2) an X-ray diffraction pattern of the quinacridone pigment (B); and
(3) an X-ray diffraction pattern of a mixture obtained by mixing the quinacridone pigments (A) and (B).

With a view to achieving the above-mentioned object, the inventors of the present invention have produced a quinacridone solid solution pigment through use of two kinds of quinacridone-based pigments, that is, unsubstituted quinacridone and 2,9-dialkylquinacridone, and have made an investigation on a relationship between the crystal structure and color developability of the quinacridone solid solution pigment. As a result, the inventors have revealed that a diffraction peak intensity at a diffraction angle 2θ of 5.9°±0.2° and a diffraction peak intensity at a diffraction angle 2θ of 6.4°±0.2°, which are obtained by X-ray diffractometry, are largely involved in the color developability.

The foregoing is described more specifically below.

A peak at a diffraction angle 2θ of 5.9°±0.2° obtained by the X-ray diffractometry is a diffraction peak inherent in the quinacridone solid solution pigment, and as its diffraction peak intensity becomes stronger and sharper, the color developability is more improved. Meanwhile, a diffraction peak at a diffraction angle 2θ of 6.4°±0.2° obtained by the X-ray diffractometry is a peak that the unsubstituted quinacridone also has. The inventors have revealed that as the ratio of the diffraction peak intensity at a diffraction angle 2θ of 6.4°±0.2° to the sum of the diffraction peak intensity at a diffraction angle 2θ of 5.9°±0.2° and the diffraction peak intensity at a diffraction angle 2θ of 6.4°±0.2° becomes smaller, the color developability is more improved.

The above-mentioned ratio concerning the diffraction peak intensities is more specifically as follows: when the diffraction peak intensity at a diffraction angle 2θ of 5.9°±0.2° and the diffraction peak intensity at a diffraction angle 2θ of 6.4°±0.2°, which are obtained by the X-ray diffractometry, are represented by T1 and T2, respectively, T1 and T2 satisfy T2/(T1+T2)≤0.13. The inventors have revealed that the satisfaction of T2/(T1+T2)≤0.13, that is, an improvement in purity of the quinacridone solid solution pigment is important for the pigment to clearly develop a color.

The inventors of the present invention have assumed the reason why the ratio of the diffraction peak intensity at a diffraction angle 2θ of 6.4°±0.2° in the X-ray diffraction pattern of the quinacridone solid solution pigment affects the color developability thereof to be as described below. In the quinacridone solid solution pigment, its respective crystal planes, such as a π-π plane, a hydrophobic plane, and a hydrogen bonding plane, form a crystal phase while growing. In forming the crystal plane, the pigment can express a color more clearly in a case where the hydrophobic plane and the hydrogen bonding plane grow to form the crystal phase than in a case where the π-π crystal plane grows to form the crystal phase. Needless to say, the amount of energy needed in forming each of the crystal planes is involved in the growth of the crystal plane. The growth is also affected by the manner in which the unsubstituted quinacridone and the 2,9-dialkylquinacridone each adsorb to the crystal plane. It is conceivable that as the ratio of the unsubstituted quinacridone adsorbing to the π-π plane increases, that is, the ratio of the diffraction peak intensity at a diffraction angle 2θ of 6.4°±0.2° reduces, purity is improved and crystal growth on the π-π plane is suppressed. The inventors of the present invention have assumed that relative acceleration of growth of the respective crystal planes, such as the hydrophobic plane and the hydrogen bonding plane, as a result of the foregoing is a reason for the improvement in color developability.

In addition, the inventors have discovered that such solid solution pigment may be produced by an approach including applying a shear force such as a salt milling method. The inventors have assumed that this is because of the following reason: unlike an approach including producing a solid solution pigment in synthesizing a quinacridone pigment like a conventional approach, in the salt milling method, a solid solution pigment is produced by causing the crystal growth of a pigment while applying a shear force thereto, and hence crystal growth on a π-π plane is suppressed. In the approach, as described later, it is important that in a kneading step, kneading be performed with a kneading energy of 15 kWh/kg or more per unit mass (kg) of quinacridone-based pigments. It is assumed that any approach enabling the production of a solid solution pigment by a shear force and crystal growth as well as the salt milling method can achieve the foregoing.

### <Quinacridone Solid Solution Pigment>

As described above, the quinacridone solid solution pigment according to one embodiment of the present invention includes at least two kinds of quinacridone-based pigments including the unsubstituted quinacridone and the 2,9-dialkylquinacridone. In addition, the quinacridone solid solution pigment is characterized in that when the diffraction peak intensity at a diffraction angle 2θ of 5.9°±0.2° and the diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.

The diffraction peak intensity T1 at a diffraction angle 2θ of 5.9°±0.2° and the diffraction peak intensity T2 at a diffraction angle 2θ of 6.4°±0.2° may be determined from an X-ray diffraction pattern obtained by the X-ray diffractometry, the pattern being measured for the quinacridone solid solution pigment. Specifically, the diffraction peak intensities may be measured by powder X-ray diffractometry through use of the quinacridone solid solution pigment as a sample. Although a value of the above-mentioned ratio “T2/(T1+T2)” is 0.13 or less, the lower limit thereof is not particularly limited, and may be, for example, 0.08 or more.

In addition, the quinacridone solid solution pigment according to one embodiment of the present invention is preferably used in an inkjet ink.

### (Quinacridone-Based Pigments)

Quinacridone-based pigments (hereinafter sometimes referred to as “raw material pigments”) including at least two kinds, that is, an unsubstituted quinacridone and 2,9-dialkylquinacridone are used as pigments for forming the quinacridone solid solution pigment. The unsubstituted quinacridone is quinacridone free of any substituent (molecular formula: C₂₀H₁₂N₂O₂) and is also referred to as “C.I. Pigment Violet 19.”

2,9-dialkylquinacridone is a substituted quinacridone (quinacridone derivative) having alkyl groups as substituents at the 2-position and 9-position of a quinacridone base structure. The alkyl groups serving as the substituents at the 2-position and the 9-position may be identical to or different from each other. The alkyl group is preferably an alkyl group having 1 or more and 6 or less carbon atoms, more preferably a methyl group, an ethyl group, a n-propyl group, an isopropyl group, a n-butyl group, a sec-butyl group, an isobutyl group, or a tert-butyl group. Among those, a methyl group is still more preferred from a viewpoint of ease of availability. In other words, 2,9-dialkylquinacridone is still more preferably 2,9-dimethylquinacridone (molecular formula: C₂₂H₁₆N₂O₂; also referred to as “C.I. Pigment Red 122”).

In addition to the use of at least two kinds, that is, the unsubstituted quinacridone and the 2,9-dialkylquinacridone described above, one or two or more kinds of other quinacridone-based pigments may be further used as a raw material pigment of the quinacridone solid solution pigment. An example of the other quinacridone-based pigments may be a quinacridone derivative having a halogen atom as a substituent (halogenated quinacridone). Examples of the halogenated quinacridone may include 2,9-dichloroquinacridone (also referred to as “C.I. Pigment Red 202”) and 3,10-dichloroquinacridone (also referred to as “C.I. Pigment Red 209”).

The inventors of the present invention have made a further investigation, and as a result, have found that a ratio of the unsubstituted quinacridone to the 2,9-dialkylquinacridone, and a particle diameter and an aspect ratio (major-axis particle diameter/minor-axis particle diameter) of the quinacridone solid solution pigment also affect the color developability and hue of the quinacridone solid solution pigment.

That is, from a viewpoint that a quinacridone solid solution pigment that can develop a color more clearly is easily obtained, a mass proportion of the unsubstituted quinacridone to the 2,9-dialkylquinacridone is preferably 80:20 or more and 60:40 or less. The above-mentioned mass proportion represents a ratio “(content of unsubstituted quinacridone on mass basis):(content of 2,9-dialkylquinacridone on mass basis)” in the quinacridone solid solution pigment. In other words, the mass ratio of the content of the unsubstituted quinacridone to the content of the 2,9-dialkylquinacridone is preferably 1.5 times or more and 4.0 times or less. The mass proportion and the mass ratio described above may be determined by quantitative analysis including using an apparatus based on a nuclear magnetic resonance (NMR) method. In addition, the mass proportion and the mass ratio may be adjusted by the loading amounts of the pigments in the kneading step.

In addition, from a viewpoint that a quinacridone solid solution pigment that can develop a color more clearly is easily obtained, the arithmetic average particle diameter (volume average) of the quinacridone solid solution pigment is preferably 50 nm or more and 150 nm or less by taking in consideration of the unevenness of a pigment layer on a recording medium in recording an image on the recording medium with an ink containing the quinacridone solid solution pigment. When the arithmetic average particle diameter (volume average) of the quinacridone solid solution pigment is 50 nm or more and 150 nm or less, the pigment can express a color more clearly. The above-mentioned arithmetic average particle diameter (volume average) is more preferably 90 nm or more and 140 nm or less.

The following method may be adopted as a method of measuring the above-mentioned arithmetic average particle diameter. A dispersion liquid containing the quinacridone solid solution pigment and water is used as a sample. The sample is observed with a scanning electron microscope (SEM), and an image thereof is taken. The taken SEM image (magnification after its enlargement: 30,000) is input in a scanner and digitized, followed by computer image analysis. Then, the arithmetic average particle diameter can be determined as an arithmetic average (volume average) from the distribution of the diameters (equivalent circle diameters) of circles having areas equal to the projected areas of 1000 pieces of the respective extracted primary particles.

The aspect ratio (major-axis particle diameter/minor-axis particle diameter) of the quinacridone solid solution pigment is preferably 1.1 or more and 1.7 or less. The reason why the desired range of the aspect ratio (major-axis particle diameter/minor-axis particle diameter) is 1.1 or more and 1.7 or less is described as follows. In the quinacridone solid solution pigment, a hydrophobic plane and a hydrogen bonding plane that contribute to clear color development, and a π-π plane that does not contribute thereto form a crystal phase while growing. The inventors have conceived that in the case where the aspect ratio is less than 1.1, not only the hydrophobic plane and the hydrogen bonding plane but also the π-π plane that does not contribute to clear color development undergoes crystal growth, and hence clear color development is not achieved. In addition, the inventors have conceived that in the case where the aspect ratio is more than 1.7, even when only the hydrophobic plane and the hydrogen bonding plane are selectively grown, secondary aggregation is liable to occur, and hence the color developability of the pigment reduces.

A pigment having such an aspect ratio as described above is preferably produced by using a salt milling method by which a shape of the pigment can be controlled. In this case, possible approaches to reducing the aspect ratio include a reduction in amount of a water-soluble inorganic salt in an applicable range, a reduction in kneading energy, and a reduction in temperature. Meanwhile, to increase the aspect ratio, approaches contrary to those described above only need to be adopted.

The aspect ratio may be measured by the following method. The quinacridone solid solution pigment is sufficiently diluted with water to provide a dispersion liquid, and then an image thereof is taken with a scanning electron microscope (SEM). The taken SEM image (magnification after its enlargement: 1,000,000) is input in a scanner and digitized, followed by computer image analysis. Then, the lengths of the major axis and minor axis of each of 100 particles are measured, and a ratio between the respective averages (major axis value/minor axis value) may be measured as the “aspect ratio.”

A method of producing the quinacridone solid solution pigment according to this embodiment is not particularly limited. Meanwhile, from a viewpoint that a quinacridone solid solution pigment satisfying T2/(T1+T2)≤0.13 is easily obtained, and from a viewpoint that the above-mentioned preferred quinacridone solid solution pigment is easily obtained, the quinacridone solid solution pigment is preferably produced by using the salt milling method. Further, the quinacridone solid solution pigment is more preferably produced by a method of producing a quinacridone solid solution pigment according to one embodiment of the present invention described below, the method including a kneading step including using the salt milling method.

### <Method of Producing Quinacridone Solid Solution Pigment>

A method of producing a quinacridone solid solution pigment according to one embodiment of the present invention includes a kneading step of kneading a mixture containing raw material pigments (quinacridone-based pigments), a water-soluble inorganic salt, and a water-soluble organic solvent with a kneading apparatus to provide a pigment-kneaded product containing the quinacridone solid solution pigment.

### [Kneading Step]

The kneading step is a step of kneading a mixture containing quinacridone-based pigments, a water-soluble inorganic salt, and a water-soluble organic solvent with kneading apparatus. As described above, at least two kinds, that is, unsubstituted quinacridone and 2,9-dialkylquinacridone are used as the quinacridone-based pigments, and the mass proportion “(unsubstituted quinacridone):(2,9-dialkylquinacridone)” is preferably from 80:20 to 60:40. In addition, in addition to the above-mentioned two kinds, any other quinacridone-based pigment may be further used as required. The kneading step can miniaturize raw material pigments, and hence can provide a pigment-kneaded product containing the quinacridone solid solution pigment as a miniaturized pigment.

Although the kneading apparatus is not particularly limited, kneading apparatus, such as batch-type and continuous kneading apparatus, and normal pressure-type, pressure-type, and decompression-type kneading apparatus, may each be used, and an apparatus that kneads contents while applying a load to compress the contents may be suitably used. In addition, a kneading apparatus including, for example, a material loading portion, such as a kneading kiln or a hopper, and a stirring portion for stirring a material, such as a stirring blade, a mixing blade, a blade, a screw, or a roll, may be suitably used. Specific examples of the kneading apparatus may include kneading apparatus, such as a kneader, a roll mill, a ball mill, an attritor, a sand mill, a planetary mixer, and a continuous single-screw kneader.

The planetary mixer may be, for example, TRIMIX (product name) manufactured by Inoue MFG., Inc. In addition, the continuous single-screw kneader may be, for example, MIRACLE KCK (product name) manufactured by Asada Iron Works Co., Ltd.

A method for the kneading step is, for example, a method including: loading the raw material pigments, the water-soluble inorganic salt, and the water-soluble organic solvent into the material loading portion of the kneading apparatus such as a kneading kiln; then setting, for example, a number of revolutions of the stirring portion of the kneading apparatus such as a stirring blade, a temperature in kneading, and a kneading time; and starting the kneading. The kneading applies kneading energy to the raw material pigments.

In the method of producing a quinacridone solid solution pigment of the present invention, in the above-mentioned kneading step, the mixture is kneaded with a kneading energy of 15 kWh/kg or more per unit mass (kg) of the quinacridone-based pigments. Thus, a quinacridone solid solution pigment satisfying T2/(T1+T2)≤0.13 is easily obtained. Further, a quinacridone solid solution pigment having an arithmetic average particle diameter (volume average) in the range of from 50 nm or more to 150 nm or less can be obtained, and a quinacridone solid solution pigment having an orderly particle size distribution can also be obtained. The above-mentioned kneading energy is more preferably 18 kWh/kg or more, still more preferably 20 kWh/kg or more, and is preferably 30 kWh/kg or less from a viewpoint of a production cost.

The kneading energy to be applied to the raw material pigments may be adjusted by, for example, a mixing ratio among the raw material pigments (quinacridone-based pigments), the water-soluble inorganic salt, and the water-soluble organic solvent; the number of revolutions of the stirring portion of the kneading apparatus such as a stirring blade; and a kneading time. The above-mentioned kneading energy is integrated shear energy per 1 kg of the raw material pigments.

Regarding the mixing ratio among the raw material pigments, the water-soluble inorganic salt, and the water-soluble organic solvent, the following ratios are preferably adopted with respect to a usage amount (mass) of the quinacridone-based pigments. A mass ratio of the usage amount of the water-soluble inorganic salt to the usage amount of the quinacridone-based pigments is preferably 3.0 times or more and 20.0 times or less, more preferably 5.0 times or more and 10.0 times or less. In addition, the mass ratio of the usage amount of the water-soluble organic solvent to the usage amount of the quinacridone-based pigments is preferably 0.5 times or more and 5.0 times or less, more preferably 0.8 times or more and 3.0 times or less, still more preferably 1.0 times or more and 1.5 times or less.

A set temperature of the kneading apparatus in the kneading step is preferably 80° C. or more, more preferably 100° C. or more. When the set temperature of the kneading apparatus in the kneading step falls within the above-mentioned ranges, a quinacridone solid solution pigment having high purity (a value of the ratio “T2/(T1+T2)” of 0.13 or less) is easily obtained. In the kneading step, the mixture is more preferably kneaded under such a condition that the set temperature of the kneading apparatus is 100° C. or more, and a temperature of a kneaded product in a kneading process becomes 100° C. or more. An upper limit of the set temperature of the kneading apparatus is not particularly limited but is preferably 150° C. or less from a viewpoint of a production cost.

### (Water-Soluble Inorganic Salt)

The water-soluble inorganic salt to be used in the kneading step crushes raw material pigments in the kneading step through utilization of its high hardness to contribute to pigment miniaturization. The water-soluble inorganic salt is not particularly limited as long as the inorganic salt is dissolved in water. Specific examples of the water-soluble inorganic salt may include sodium chloride, potassium chloride, sodium sulfate, zinc chloride, calcium chloride, and magnesium chloride, and a mixture of two or more kinds thereof. Among those, sodium chloride is preferably used in terms of price.

The arithmetic average particle diameter of the water-soluble inorganic salt is preferably 1 μm or more and 250 μm or less.

A method of measuring the arithmetic average particle diameter of the water-soluble inorganic salt is as described below. The water-soluble inorganic salt is observed with an optical microscope, and an image thereof is taken. The taken image is input in a scanner and digitized, followed by computer image analysis. Then, the arithmetic average particle diameter (volume average) can be determined from a distribution of diameters (equivalent circle diameter) of circles having areas equal to projected areas of 1000 pieces of respective particles extracted in the image analysis. The arithmetic average particle diameter of a water-soluble inorganic salt used in each of Examples to be described later was also determined by the above-mentioned measurement method.

### (Water-Soluble Organic Solvent)

The water-soluble organic solvent to be used in the kneading step is intended to moisten a mixture of raw material pigments and a water-soluble inorganic salt to produce dough (lump obtained by kneading) having moderate hardness. Thus, a strong load is applied to the kneaded product to serve to generate crushed surfaces of the pigments.

The water-soluble organic solvent is not particularly limited, and examples thereof may include an alcohol, a glycol, an ether, and an aprotic polar solvent. Specific examples of the water-soluble organic solvent may include 2-(methoxymethoxy)ethanol, 2-butoxyethanol, 2-(isopentyloxy)ethanol, 2-(hexyloxy)ethanol, diethylene glycol, diethylene glycol monomethyl ether, diethylene glycol monoethyl ether, diethylene glycol monobutyl ether, triethylene glycol, triethylene glycol monomethyl ether, liquid polyethylene glycol, 1-methoxy-2-propanol, 1-ethoxy-2-propanol, dipropylene glycol, dipropylene glycol monomethyl ether, dipropylene glycol monoethyl ether, low-molecular-weight polypropylene glycol, aniline, pyridine, tetrahydrofuran, dioxane, methanol, ethanol, isopropanol, n-propanol, isobutanol, n-butanol, ethylene glycol, propylene glycol, propylene glycol monomethyl ether acetate, ethyl acetate, isopropyl acetate, acetone, methyl ethyl ketone, dimethylformamide, dimethyl sulfoxide, N-methylpyrrolidone, and N,N-dimethylformamide. The above-mentioned water-soluble organic solvents may be used alone or as a mixture thereof as required.

### (Other Materials)

In the kneading step, in producing the quinacridone solid solution pigment, in addition to the raw material pigments, the water-soluble inorganic salt, and the water-soluble organic solvent, a dye derivative or a resin may be added for a purpose of adjusting crystal growth and crystal dislocation of each of the quinacridone solid solution pigments. A dye derivative using the same structure as that of each of the raw material pigments as a parent body is preferred as a dye derivative, and a dye derivative having a structure different therefrom is preferred.

### [Purifying Step]

In one aspect of the method of producing a quinacridone solid solution pigment according to this embodiment, the method preferably further includes a purifying step of removing a water-soluble inorganic salt and a water-soluble organic solvent from a pigment-kneaded product containing the quinacridone solid solution pigment obtained in the above-mentioned kneading step. Through the purifying step, a pigment composition containing the quinacridone solid solution pigment, the composition resulting from the removal of the water-soluble inorganic salt and the water-soluble organic solvent from the pigment-kneaded product, can be obtained.

The following method is preferably adopted as the purifying step from a viewpoint that a pigment dispersion to be described later is easily produced by using the pigment-kneaded product obtained by the above-mentioned kneading step. Firstly, an aqueous medium such as water, whose amount is enough to dissolve the water-soluble inorganic salt and the water-soluble organic solvent in the pigment-kneaded product obtained in the above-mentioned kneading step, and the pigment-kneaded product are stirred and mixed so that the water-soluble inorganic salt and the water-soluble organic solvent in the pigment-kneaded product may be dissolved in the aqueous medium. Thus, a first pigment suspension is obtained. Next, the first pigment suspension is filtered to provide a second pigment suspension resulting from the removal of the water-soluble inorganic salt and the water-soluble organic solvent from the first pigment suspension. As described above, it is more preferred that the water-soluble inorganic salt and the water-soluble organic solvent are removed from the pigment-kneaded product through the first pigment suspension, and the second pigment suspension containing the quinacridone solid solution pigment and water are obtained as a suspension from which these materials have been removed. The aqueous medium to be used in the purifying step is preferably water from a viewpoint of washability, and ion-exchanged water is more preferred.

To suppress the clogging of a filter with the quinacridone solid solution pigment obtained by the kneading step, a purifying apparatus of a crossflow filtration system is preferably used as a purifying apparatus that may be used in the purifying step. In the purifying apparatus of a crossflow filtration system, a method including passing a liquid through an ultrafiltration membrane for plural times is more preferably used.

The second pigment suspension obtained through the purifying step is subjected as a liquid composition to a moisture-adjusting step to be described later, and a dispersant is added as required to a resultant pigment suspension (third pigment suspension) whose moisture content has been adjusted. Thus, a pigment dispersion to be described later can be prepared. In addition, the pigment dispersion to be described later may be prepared by adding water, and the dispersant to the quinacridone solid solution pigment as required, which has been dried through the removal of most of its moisture by a moisture-adjusting step. Further, an inkjet aqueous ink may be obtained by appropriately adding, for example, a water-soluble organic solvent and an additive as required to the pigment dispersion.

### [Moisture-Adjusting Step]

The method of producing a quinacridone solid solution pigment of the present invention preferably further includes a moisture-adjusting step of heating a liquid composition containing a quinacridone solid solution pigment obtained in the kneading step and water at a temperature equal to or less than the set temperature of a kneading apparatus in the kneading step to evaporate its moisture, to thereby adjust a moisture content of the liquid composition.

The inventors of the present invention have discovered that a purity of the quinacridone solid solution pigment may reduce in the moisture-adjusting step.

After water had been added to the pigment-kneaded product containing the quinacridone solid solution pigment obtained by a salt milling method, the purifying step of passing the mixture through a filter to remove its water-soluble inorganic salt and water-soluble organic solvent was performed. Further, after the purifying step, the moisture-adjusting step of heating the liquid composition containing the quinacridone solid solution pigment and water to evaporate its moisture, to thereby adjust the moisture content of the liquid composition was performed. The quinacridone solid solution pigment obtained through the moisture-adjusting step (dry quinacridone solid solution pigment) was subjected to X-ray diffraction measurement again. As a result, it was found that purity of the quinacridone solid solution pigment reduced to increase the value of the ratio “T2/(T1+T2)” in some cases.

The inventors of the present invention have made an investigation, and as a result, have revealed that a main cause for a reduction in purity of the quinacridone solid solution pigment obtained by the salt milling method through the moisture-adjusting step lies in a relationship between the heating temperature of the kneading step and the heating temperature of the moisture-adjusting step. More specifically, the inventors have revealed that in a case where the moisture-adjusting step is performed by heating at a temperature higher than the set temperature of the kneading apparatus in the kneading step, as a difference between the temperatures becomes larger, the purity of the quinacridone solid solution pigment is more liable to reduce. The inventors of the present invention have assumed the reason why the set temperature of the kneading step and the heating temperature of the moisture-adjusting step affect the purity of the quinacridone solid solution pigment to be as described below.

Even when a quinacridone solid solution pigment having high purity can be produced by the kneading step, an ultrafine-particle diameter quinacridone-based pigment (hereinafter referred to as “fine raw material pigment”) that is not turned into a solid solution remains in the resultant quinacridone solid solution pigment, though only slightly. After the kneading step, when the moisture-adjusting step is performed at a temperature higher than the set temperature in the kneading step, the remaining fine raw material pigment may rapidly undergo crystal growth into a particle diameter enough to affect the color developability of the quinacridone solid solution pigment. This is assumed to be a cause for the reduction in purity of the quinacridone solid solution pigment obtained after the moisture-adjusting step. In addition, the fine raw material pigment is present in an unstable condition, and is hence assumed to grow into a stable crystal form depending on temperature hysteresis given to the pigment. Probably because of the foregoing, when the temperature in the moisture-adjusting step is equal to or less than the set temperature in the kneading step, the quinacridone solid solution pigment to be subjected to the moisture-adjusting step has already had a crystal form stable against the temperature in adjusting its moisture content, and hence its purity hardly reduces.

Accordingly, to maintain the quinacridone solid solution pigment obtained in the kneading step in which the value of the ratio “T2/(T1+T2)” is 0.13 or less, in the moisture-adjusting step, the moisture of the liquid composition containing the quinacridone solid solution pigment obtained in the kneading step and water needs to be evaporated by heating the liquid composition at a temperature equal to or less than the set temperature of the kneading apparatus in the kneading step. The second pigment suspension obtained by the above-mentioned purifying step is preferably used as the liquid composition.

The temperature in the moisture-adjusting step is preferably lower than the set temperature in the kneading step described above by 10° C. or more. When a difference between the set temperature in the kneading step and the temperature in the moisture-adjusting step, that is, a temperature difference obtained by subtracting the temperature in the moisture-adjusting step from the set temperature in the kneading step is 10° C. or more, the purity of the quinacridone solid solution pigment after the moisture-adjusting step is more easily improved. From a viewpoint that the temperature in the moisture-adjusting step can be increased, the above-mentioned temperature difference is preferably 70° C. or less, more preferably 50° C. or less.

A specific method for the moisture-adjusting step may be, for example, a method including removing moisture from the liquid composition with one or two or more kinds of, for example, a filter press, a pressure filtration apparatus, a hot-air dryer, a heating dryer, and a heat transfer-type dryer. When a filter such as a filter press is used, to improve filterability, the moisture-adjusting step is desirably performed so that the filter may not be clogged with the quinacridone solid solution pigment. In addition, when a heating dryer is used, the moisture-adjusting step is preferably performed so that an increase in particle diameter and an increase in number of coarse particles due to the secondary aggregation of particles of the pigment along with its drying may be suppressed. Meanwhile, in the moisture-adjusting step, the moisture content of the liquid composition is preferably adjusted by bringing the liquid composition into contact with a heat source because a local moisture content difference (also referred to as “drying unevenness”) of the third pigment suspension after its moisture adjustment is small, and the moisture content thereof can be freely adjusted.

An apparatus that brings the liquid composition into direct contact with its heat source to adjust the moisture content of the liquid composition is, for example, a heat transfer-type dryer. The heat transfer-type dryer is, for example, CD DRYER (product name) manufactured by Nishimura Works Co., Ltd.

When the heat transfer-type dryer is used in the moisture-adjusting step, a following method may be adopted. After a temperature and number of revolutions of a disc serving as a heat source with which the liquid composition is brought into direct contact (hereinafter referred to as “heat source disc”) have been set, the liquid composition is sprayed on a rotating heat source disc, and its moisture is evaporated until a desired moisture content is obtained. After that, the residue on the heat source disc is collected. Thus, the third pigment suspension whose moisture content has been adjusted to a desired value and a dried quinacridone solid solution pigment can be obtained.

### <Pigment Dispersion>

Next, a pigment dispersion according to one embodiment of the present invention is described. The pigment dispersion of the present invention is a pigment dispersion including a dispersion medium and a pigment dispersed in the dispersion medium, the pigment dispersion is characterized in that the pigment is the above-mentioned quinacridone solid solution pigment. The pigment dispersion includes the dispersion medium and the pigment dispersed in the dispersion medium. The pigment in the pigment dispersion is the above-mentioned quinacridone solid solution pigment. For example, the dispersion medium may be the aqueous medium such as water to be used when the above-mentioned first pigment suspension is obtained, or may be an aqueous medium such as water that can be used in an aqueous ink to be described later. The pigment dispersion may further include a dispersant to be described later.

<Method of producing Pigment Dispersion>

A method of producing a pigment dispersion according to one embodiment of the present invention includes a dispersing step of dispersing a quinacridone solid solution pigment in a dispersion medium after removing a water-soluble inorganic salt and a water-soluble organic solvent from a pigment-kneaded product obtained by the method of producing a quinacridone solid solution pigment according to one embodiment of the present invention described above (e.g., the above-mentioned kneading step). Thus, a pigment dispersion including the quinacridone solid solution pigment obtained by the method of producing a quinacridone solid solution pigment can be produced.

### [Dispersing Step]

The method described in the above-mentioned purifying step may be adopted as a method of removing the water-soluble inorganic salt and the water-soluble organic solvent from the pigment-kneaded product. Accordingly, a pigment composition containing a quinacridone solid solution pigment, a pigment composition resulting from the removal of the water-soluble inorganic salt and the water-soluble organic solvent from the pigment-kneaded product, may be used as the quinacridone solid solution pigment to be dispersed in the dispersion medium in the dispersing step.

The second pigment suspension obtained in the above-mentioned purifying step, or the third pigment suspension or the dry quinacridone solid solution pigment obtained in the moisture-adjusting step may be preferably used as the pigment composition, and the dry quinacridone solid solution pigment may be more preferably used. As described above, the aqueous medium such as water to be used when the first pigment suspension is obtained may be used as it is as the dispersion medium, or an aqueous medium such as water that may be incorporated into an ink to be described later may be further used.

In the dispersing step, a dispersing apparatus that disperses the quinacridone solid solution pigment in the dispersion medium may be used. Examples of the dispersion apparatus may include a high-pressure homogenizer, a paint shaker, a ball mill, a sand mill, a sand grinder, DYNO-MILL, DISPERMAT, an SC mill, a spike mill, Nanomizer, an agitator mill, and a planetary mixer. Those dispersion apparatus may be used alone or in combination thereof.

In addition, in the dispersing step, a dispersant is preferably used for stably dispersing the quinacridone solid solution pigment in the dispersion medium. A suitable dispersant may be, for example, an alkali-soluble polymer compound (hereinafter referred to as “resin dispersant”). A dispersant that can stably disperse a pigment in an aqueous medium by the action of an anionic group is suitably used as the resin dispersant.

For example, a polymer compound obtained by polymerizing a material containing one or two or more kinds of such monomers as described below is preferably used. Examples of the monomers include: hydrophobic monomers, such as styrene, α-methylstyrene, n-butyl acrylate, n-hexyl acrylate, and benzyl methacrylate; hydrophilic monomers each having a carboxy group, such as acrylic acid, methacrylic acid, crotonic acid, ethacrylic acid, propylacrylic acid, isopropylacrylic acid, itaconic acid, and fumaric acid; hydrophilic monomers each having a sulfonic acid group, such as styrenesulfonic acid, sulfonic acid-2-propylacrylamide, acrylic acid-ethyl 2-sulfonate, methacrylic acid-ethyl 2-sulfonate, and butyl acrylamide sulfonic acid; and hydrophilic monomers each having a phosphonic acid group, such as methacrylic acid-ethyl 2-phosphonate and acrylic acid-ethyl 2-phosphonate.

The weight-average molecular weight (Mw) of the resin dispersant is preferably 1,000 or more and 30,000 or less, more preferably 3,000 or more and 15,000 or less. The weight-average molecular weight of the resin dispersant may have a value based on standard polystyrene measured by using gel permeation chromatography (GPC). An acid value (mgKOH/g) of the resin dispersant is preferably 40 mgKOH/g or more and 300 mgKOH/g or less, more preferably 100 mgKOH/g or more and 250 mgKOH/g or less. The acid value of the resin dispersant may have a value measured with a potentiometric titrator using a potassium hydroxide-methanol titrant. A usage amount of the resin dispersant is preferably 10 mass % or more and 50 mass % or less with respect to an usage amount of the pigment.

The quinacridone solid solution pigment according to one embodiment of the present invention described above and the pigment dispersion including the pigment may be suitably used in any application as long as the application requires a coloring function. Examples of such application may include a paint, a printing ink, a colored molded article, toner for developing an electrostatic charge image, a color filter for a liquid crystal display apparatus, and an inkjet ink. Among those, an inkjet ink is preferred because the use of the above-mentioned quinacridone solid solution pigment as a coloring material can record an image that develops a color more clearly.

### <Ink>

An inkjet ink using the above-mentioned quinacridone solid solution pigment is described below.

### (Coloring Material)

The ink includes the above-mentioned quinacridone solid solution pigment as a coloring material. In preparing of the ink, the above-mentioned pigment dispersion is preferably used. The content (mass %) of the quinacridone solid solution pigment in the ink is preferably 0.1 mass % or more and 15.0 mass % or less, more preferably 1.0 mass % or more and 10.0 mass % or less with respect to the total mass of the ink. A dye or the like may be incorporated into the ink for toning or the like together with the quinacridone solid solution pigment.

### (Aqueous Medium)

The ink is preferably an aqueous ink including at least water as an aqueous medium. Water or an aqueous medium, which is a mixed solvent of water and a water-soluble organic solvent, may be used in the ink. Deionized water (ion-exchanged water) is preferably used as the water. The content (mass %) of the water in the ink is preferably 10.0 mass % or more and 90.0 mass % or less, more preferably 50.0 mass % or more and 90.0 mass % or less with respect to a total mass of the ink.

Solvents that may be used in inkjet inks may each be used as the water-soluble organic solvent that may be incorporated into the ink. Examples thereof include alcohols, (poly)alkylene glycols, glycol ethers, nitrogen-containing compounds, and sulfur-containing compounds. Among those, a water-soluble organic solvent whose vapor pressure at 25° C. is lower than that of water is preferably used. The content (mass %) of the water-soluble organic solvent in the ink is preferably 5.0 mass % or more and 85.0 mass % or less, more preferably 9.0 mass % or more and 49.0 mass % or less based on the total mass of the ink.

### (Other Additives)

The ink may include water-soluble organic compounds that are solid at normal temperature, the compounds including: polyhydric alcohols, such as trimethylolpropane and trimethylolethane; urea and urea derivatives, such as ethyleneurea and hydantoin; and sugars, as required, in addition to the above-mentioned components. Further, the ink may include various additives, such as a surfactant, a pH adjuster, a rust inhibitor, an antiseptic agent, a fungicide, an antioxidant, a reduction inhibitor, an evaporation accelerator, a chelating agent, and a water-soluble resin, as required.

### <Ink Cartridge>

When the above-mentioned ink is used in an inkjet recording method, an ink cartridge may be used. The ink cartridge includes the above-mentioned ink and an ink-storing portion for storing the ink. Further, an ink cartridge of a form configured to include the ink-storing portion and a recording head is preferred.

### <Inkjet Recording Method>

An inkjet recording method is a method including discharging the above-mentioned ink from a recording head of an inkjet system to record an image on a recording medium. A system for the discharge of the ink is, for example, a system including applying mechanical energy to the ink or a system including applying thermal energy to the ink.

The step of the inkjet recording method is a known step except that the above-mentioned ink is used.

According to one aspect of the present invention, there can be provided the quinacridone solid solution pigment that develops a color more clearly than a conventional pigment does.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass, unless otherwise stated.

### <Production of Quinacridone Solid Solution Pigment>

Unsubstituted quinacridone (C.I. Pigment Violet 19), 2,9-dimethylquinacridone (C.I. Pigment Red 122), and 2,9-dichloroquinacridone (C.I. Pigment Red 202) were prepared as raw material pigments. In addition, sodium chloride (hereinafter also referred to as “NaCl”) having an arithmetic average particle diameter of 115 μm was prepared as a water-soluble inorganic salt, and diethylene glycol (hereinafter also referred to as “DEG”) was prepared as a water-soluble organic solvent.

Respective materials shown in the upper section of each of Tables 1 (Table 1-1 to Table 1-4) were mixed at mass ratios shown in the upper section of each of Tables 1 with respect to (1.0) a total mass of the raw material pigments, and were then loaded into a kneading kiln of a kneading apparatus (available under the product name “TRIMIX” from Inoue MFG., Inc. or the product name “PBV-0.3” from Irie Shokai Co., Ltd.). Then, a kneading step was performed by adopting, as kneading conditions, kneading energy (kWh/kg) per 1 kg of raw material pigments and a set temperature (° C.) of the kneading apparatus shown in the middle section of each of Tables 1. Thus, respective pigment-kneaded products 1 to 30 were obtained. In kneading, the temperature of each of the kneaded products was measured with a temperature sensor set in the kneading apparatus.

### <X-Ray Crystallography of Quinacridone Solid Solution Pigment>

A resultant pigment-kneaded products 1 to 30 were each washed with water sufficiently, filtered, and dried at normal temperature, and then a pigment composition containing a quinacridone solid solution pigment was obtained. A pigment composition containing the quinacridone solid solution pigment was used as a sample, and its powder X-ray diffraction measurement was performed with an X-ray diffraction apparatus (product name: “X'Pert Pro”, manufactured by Malvern Panalytical) using CuKα ray. As a result, each of quinacridone solid solution pigments contained in the pigment-kneaded products 1 to 30 showed a diffraction peak at a diffraction angle 2θ of 5.9°±0.2° and a diffraction peak at a diffraction angle 2θ of 6.4°±0.2°. The values of a diffraction peak intensity T1 at a diffraction angle 2θ of 5.9°±0.2° and a diffraction peak intensity T2 at a diffraction angle 2θ of 6.4°±0.2°, and the ratio “T2/(T1+T2)” are shown in Tables 1. Purity of the quinacridone solid solution pigment was judged to be high when the ratio of T2/(T1+T2) was 0.13 or less.

The value of the ratio “T2/(T1+T2)” of the pigment-kneaded product 19 was more than 0.13 probably because the set temperature of the kneading apparatus was 100° C., but a temperature of the kneaded product was 98° C. Meanwhile, a value of the ratio “T2/(T1+T2)” of the pigment-kneaded product 10 became 0.13 because the set temperature of the kneading apparatus and the temperature of the kneaded product were each 99° C. In addition, the value of the ratio “T2/(T1+T2)” of each of the pigment-kneaded products 24, 25, 29, and 30 became a value much more than 0.13 because the set temperature of the kneading apparatus and the temperature of the kneaded product were extremely low, and the kneading energy was also low, and hence a process for turning the kneaded product into a solid solution did not advance.

TABLE 1-1

| Pigment-kneaded product No. | | 1 | 2 | 3 | 4 | 5 | 6 | 7 | 8 |
|---|---|---|---|---|---|---|---|---|---|
| Raw | Unsubstituted quinacridone | 0.7 | 0.7 | 0.7 | 0.7 | 0.7 | 0.7 | 0.7 | 0.7 |
| material | 2,9-Dialkylquinacridone | 0.3 | 0.25 | 0.3 | 0.3 | 0.3 | 0.3 | 0.3 | 0.3 |
| pigment | Dichloroquinacridone | | 0.05 | | | | | | |
| Water-soluble inorganic salt (NaCl) | | 7.0 | 7.0 | 7.0 | 8.0 | 6.0 | 7.0 | 7.0 | 7.0 |
| Water-soluble organic solvent (DEG) | | 1.0 | 1.0 | 1.5 | 1.0 | 1.0 | 1.0 | 1.1 | 1.0 |
| Apparatus | TRIMIX | ∘ | ∘ | ∘ | ∘ | ∘ | ∘ | ∘ | ∘ |
| | PBV-03 | | | | | | | | |
| Kneading | Kneading energy (kWh/kg) | 20 | 20 | 20 | 20 | 20 | 25 | 18 | 15 |
| condition | Temperature (° C.) | 105 | 105 | 105 | 105 | 105 | 105 | 105 | 105 |
| Temperature of kneaded product (° C.) | | 105 | 105 | 105 | 105 | 105 | 105 | 105 | 105 |
| X-ray | Peak intensity T1 (diffraction angle | 1.20 | 1.10 | 0.87 | 1.20 | 1.20 | 1.20 | 1.20 | 1.20 |
| diffraction | 2θ = 5.9° ± 0.2°) | | | | | | | | |
| | Peak intensity T2 (diffraction angle | 0.13 | 0.13 | 0.13 | 0.13 | 0.13 | 0.13 | 0.13 | 0.15 |
| | 2θ = 6.4° ± 0.2°) | | | | | | | | |
| | Peak intensity ratio T2/(T1 + T2) | 0.10 | 0.11 | 0.13 | 0.10 | 0.10 | 0.10 | 0.10 | 0.11 |

TABLE 1-2

| Pigment-kneaded product No. | | 9 | 10 | 11 | 12 | 13 | 14 | 15 | 16 |
|---|---|---|---|---|---|---|---|---|---|
| Raw | Unsubstituted quinacridone | 0.7 | 0.7 | 0.7 | 0.7 | 0.7 | 0.7 | 0.7 | 0.7 |
| material | 2,9-Dialkylquinacridone | 0.3 | 0.3 | 0.3 | 0.3 | 0.3 | 0.3 | 0.3 | 0.3 |
| pigment | Dichloroquinacridone | | | | | | | | |
| Water-soluble inorganic salt (NaCl) | | 7.0 | 7.0 | 7.0 | 8.0 | 6.0 | 9.0 | 6.0 | 7.0 |
| Water-soluble organic solvent (DEG) | | 1.0 | 1.0 | 1.0 | 1.0 | 1.0 | 1.0 | 1.0 | 1.0 |
| Apparatus | TRIMIX | ∘ | ∘ | ∘ | ∘ | ∘ | ∘ | ∘ | ∘ |
| | PBV-03 | | | | | | | | |
| Kneading | Kneading energy (kWh/kg) | 15 | 20 | 14 | 25 | 16 | 20 | 15 | 20 |
| condition | Temperature (° C.) | 100 | 99 | 105 | 105 | 105 | 105 | 105 | 110 |
| Temperature of kneaded product (° C.) | | 100 | 99 | 105 | 105 | 105 | 105 | 105 | 107 |
| X-ray | Peak intensity T1 (diffraction | 1.20 | 0.87 | 1.20 | 1.30 | 1.20 | 1.30 | 1.20 | 1.20 |
| diffraction | angle 2θ = 5.9° ± 0.2°) | | | | | | | | |
| | Peak intensity T2 (diffraction | 0.15 | 0.13 | 0.15 | 0.12 | 0.13 | 0.12 | 0.16 | 0.12 |
| | angle 2θ = 6.4° ± 0.2°) | | | | | | | | |
| | Peak intensity ratio | 0.11 | 0.13 | 0.11 | 0.08 | 0.10 | 0.08 | 0.12 | 0.09 |
| | T2/(T1 + T2) | | | | | | | | |

TABLE 1-3

| Pigment-kneaded product No. | | 17 | 18 | 19 | 20 | 21 | 22 | 23 |
|---|---|---|---|---|---|---|---|---|
| Raw | Unsubstituted quinacridone | 0.7 | 0.7 | 0.7 | 0.7 | 0.7 | 0.7 | 0.7 |
| material | 2,9-Dialkylquinacridone | 0.3 | 0.3 | 0.3 | 0.3 | 0.3 | 0.3 | 0.3 |
| pigment | Dichloroquinacridone | | | | | | | |
| Water-soluble inorganic salt (NaCl) | | 7.0 | 7.0 | 7.0 | 7.0 | 5.0 | 10.0 | 7.0 |
| Water-soluble organic solvent (DEG) | | 1.0 | 1.0 | 1.0 | 1.0 | 1.0 | 1.0 | 1.0 |
| Apparatus | TRIMIX | ∘ | ∘ | ∘ | ∘ | ∘ | ∘ | |
| | PBV-03 | | | | | | | ∘ |
| Kneading | Kneading energy (kWh/kg) | 20 | 20 | 20 | 20 | 20 | 20 | 20 |
| condition | Temperature (° C.) | 130 | 108 | 100 | 130 | 110 | 110 | 110 |
| Temperature of kneaded product (° C.) | | 127 | 106 | 98 | 127 | 107 | 107 | 107 |
| X-ray | Peak intensity T1 (diffraction | 1.20 | 1.20 | 1.10 | 1.20 | 1.20 | 1.30 | 1.20 |
| diffraction | angle 2θ = 5.9° ± 0.2°) | | | | | | | |
| | Peak intensity T2 (diffraction | 0.10 | 0.13 | 0.18 | 0.10 | 0.16 | 0.12 | 0.12 |
| | angle 2θ = 6.4° ± 0.2°) | | | | | | | |
| | Peak intensity ratio | 0.08 | 0.10 | 0.14 | 0.08 | 0.12 | 0.08 | 0.09 |
| | T2/(T1 + T2) | | | | | | | |

TABLE 1-4

| Pigment-kneaded product No. | | 24 | 25 | 26 | 27 | 28 | 29 | 30 |
|---|---|---|---|---|---|---|---|---|
| Raw | Unsubstituted quinacridone | 0.7 | 0.7 | 0.8 | 0.6 | 0.8 | 0.7 | 0.7 |
| material | 2,9-Dialkylquinacridone | 0.3 | 0.3 | 0.2 | 0.4 | 0.1 | 0.3 | 0.3 |
| pigment | Dichloroquinacridone | | | | | 0.1 | | |
| Water-soluble inorganic salt (NaCl) | | 7.0 | 7.0 | 7.0 | 7.0 | 7.0 | 7.0 | 3.0 |
| Water-soluble organic solvent (DEG) | | 1.0 | 1.0 | 1.0 | 1.0 | 1.0 | 1.0 | 3.0 |
| Apparatus | TRIMIX | ∘ | ∘ | ∘ | ∘ | ∘ | ∘ | ∘ |
| | PBV-03 | | | | | | | |
| Kneading | Kneading energy (kWh/kg) | 20 | 20 | 20 | 20 | 20 | 13 | 13 |
| condition | Temperature (° C.) | 90 | 85 | 110 | 110 | 110 | 95 | 95 |
| Temperature of kneaded product (° C.) | | 88 | 83 | 107 | 107 | 107 | 95 | 95 |
| X-ray | Peak intensity T1 (diffraction | 1.10 | 1.10 | 1.20 | 1.20 | 1.20 | 1.20 | 1.20 |
| diffraction | angle 2θ = 5.9° ± 0.2°) | | | | | | | |
| | Peak intensity T2 (diffraction | 0.20 | 0.20 | 0.13 | 0.13 | 0.12 | 0.26 | 0.35 |
| | angle 2θ = 6.4° ± 0.2°) | | | | | | | |
| | Peak intensity ratio | 0.15 | 0.15 | 0.10 | 0.10 | 0.09 | 0.18 | 0.23 |
| | T2/(T1 + T2) | | | | | | | |

### <Production of Pigment Composition>

To remove NaCl and DEG from the pigment-kneaded products shown in Tables 2 (Table 2-1 to Table 2-5), water was added to the respective pigment-kneaded products to provide respective first pigment suspensions. After that, the respective first pigment suspensions were passed through an ultrafiltration apparatus so that NaCl and DEG were removed from respective first pigment suspensions. Thus, respective second pigment suspensions were obtained.

A moisture-adjusting step was performed by drying each of the respective second pigment suspensions under drying conditions shown in each of Tables 2. Thus, pigment compositions 1 to 32 containing dried quinacridone solid solution pigments were obtained. In drying, a heat transfer-type dryer (product name: “CD DRYER”, manufactured by Nishimura Works Co., Ltd.) or a thermostat chamber (temperature chamber) (manufactured by ESPEC Corp.) was used. In the row “Temperature in kneading minus temperature in drying (° C.)” shown in the lower section of each of Tables 2, a value obtained by subtracting a temperature in the moisture-adjusting step (temperature in the above-mentioned drying conditions) from a set temperature in the kneading step is shown.

### <Evaluations of Purities of Quinacridone Solid Solution Pigments of Pigment Compositions 1 to 32>

Each of the resultant pigment compositions 1 to 32 was used as a sample, and its powder X-ray diffraction measurement was performed with the same X-ray diffraction apparatus as the apparatus described in the above-mentioned section “X-ray Crystallography of Quinacridone Solid Solution Pigment” with a CuKα ray. As a result, each of the samples, that is, the pigment compositions 1 to 32 showed a diffraction peak at a diffraction angle 2θ of 5.9°±0.2° and a diffraction peak at a diffraction angle 2θ of 6.4°±0.2° in its X-ray diffraction spectrum. Accordingly, the purity of each of the quinacridone solid solution pigments after the moisture-adjusting step was evaluated by a same evaluation method and evaluation criteria as those in the above-mentioned section “X-ray Crystallography of Quinacridone Solid Solution Pigment.” A diffraction peak intensity T1 and T2, and the ratio “T2/(T1+T2)” are shown in Tables 2.

A value of the ratio “T2/(T1+T2)” of a pigment composition 17 became 0.13, though its value in the row “Temperature in kneading minus temperature in drying (° C.)” was −5° C. It is assumed that when the temperature in kneading was set to 130° C., a quinacridone solid solution pigment having particularly high purity was obtained, and as a result, even when the purity reduced in the moisture-adjusting step, a purity fell within an allowable range. However, a production method for a pigment composition is inferior to those for the pigment compositions 16 and 18 because the temperature in kneading needs to be set to high temperature.

### <Measurement of Particle Size Distribution of Quinacridone Solid Solution Pigment>

Each of the pigment-kneaded products obtained in the kneading step was sufficiently diluted with water to provide a dispersion liquid, and then an image thereof was taken with a scanning electron microscope (SEM). The taken SEM image (magnification after its enlargement: 30,000) was input in a scanner and digitized, followed by computer image analysis. Then, an arithmetic average particle diameter (volume average) determined from the distribution of the diameters (equivalent circle diameter) of circles having areas equal to the projected areas of 1000 pieces of the respective extracted primary particles was defined as a “primary particle diameter.” The results are shown in Tables 2.

Although primary particle diameters of pigment compositions 24, 25, and 31 were each 90 nm or more and 140 nm or less, it was observed that secondary particle diameters (diameters of aggregates of the primary particles) thereof were larger than those of the other pigment compositions. This is assumed to be because the use of the thermostat chamber at high temperature in the moisture-adjusting step caused the pigments to aggregate. Meanwhile, a secondary particle diameter of each of pigment compositions 1 to 15 did not increase because the thermostat chamber was used in the moisture-adjusting step at low temperature. However, a production method including using the thermostat chamber is inferior to a method including using a heat transfer-type dryer from a viewpoint of production efficiency because a temperature is low.

### <Measurement of Aspect Ratio of Quinacridone Solid Solution Pigment>

Each of the pigment-kneaded products obtained in the kneading step was sufficiently diluted with water to provide a dispersion liquid, and then an image thereof was taken with a scanning electron microscope (SEM). The taken SEM image (magnification after its enlargement: 1,000,000) was input in a scanner and digitized, followed by computer image analysis. Then, the lengths of the major axis and minor axis of each of 100 particles were measured, and a ratio between the respective averages (major axis value/minor axis value) was defined as an “aspect ratio.” The results are shown in Tables 2.

TABLE 2-1

| Pigment composition No. | | 1 | 2 | 3 | 4 | 5 | 6 | 7 |
|---|---|---|---|---|---|---|---|---|
| Pigment-kneaded product No. | | 1 | 2 | 3 | 4 | 5 | 6 | 7 |
| Drying | Dryer | Thermostat | Thermostat | Thermostat | Thermostat | Thermostat | Thermostat | Thermostat |
| condition | | chamber | chamber | chamber | chamber | chamber | chamber | chamber |
| | Temperature (° C.) | 60 | 60 | 60 | 60 | 60 | 60 | 60 |
| Temperature in kneading minus | | 45 | 45 | 45 | 45 | 45 | 45 | 45 |
| temperature in drying (° C.) | | | | | | | | |
| X-ray | Peak intensity T1 (diffraction | 1.20 | 1.10 | 0.87 | 1.20 | 1.20 | 1.20 | 1.20 |
| diffraction | angle 2θ = 5.9° ± 0.2°) | | | | | | | |
| | Peak intensity T2 (diffraction | 0.13 | 0.13 | 0.13 | 0.13 | 0.13 | 0.13 | 0.13 |
| | angle 2θ = 6.4° ± 0.2°) | | | | | | | |
| | Peak intensity ratio | 0.10 | 0.11 | 0.13 | 0.10 | 0.10 | 0.10 | 0.10 |
| | T2/(T1 + T2) | | | | | | | |

| | | | | | | | |
|---|---|---|---|---|---|---|---|
| Primary particle diameter (nm) | 100 | 100 | 100 | 90 | 140 | 100 | 110 |
| Aspect ratio of pigment (major-axis particle | 1.5 | 1.5 | 1.5 | 1.2 | 1.5 | 1.1 | 1.7 |
| diameter/minor-axis particle diameter) | | | | | | | |

TABLE 2-2

| Pigment composition No. | | 8 | 9 | 10 | 11 | 12 | 13 | 14 |
|---|---|---|---|---|---|---|---|---|
| Pigment-kneaded product No. | | 8 | 9 | 10 | 11 | 12 | 13 | 14 |
| Drying | Dryer | Thermostat | Thermostat | Thermostat | Thermostat | Thermostat | Thermostat | Thermostat |
| condition | | chamber | chamber | chamber | chamber | chamber | chamber | chamber |
| | Temperature (° C.) | 60 | 60 | 60 | 60 | 60 | 60 | 60 |
| Temperature in kneading minus | | 45 | 40 | 39 | 45 | 45 | 45 | 45 |
| temperature in drying (° C.) | | | | | | | | |
| X-ray | Peak intensity T1 (diffraction | 1.20 | 1.20 | 0.87 | 1.20 | 1.30 | 1.20 | 1.30 |
| diffraction | angle 2θ = 5.9° ± 0.2°) | | | | | | | |
| | Peak intensity T2 (diffraction | 0.15 | 0.15 | 0.13 | 0.15 | 0.12 | 0.13 | 0.12 |
| | angle 2θ = 6.4° ± 0.2°) | | | | | | | |
| | Peak intensity ratio | 0.11 | 0.11 | 0.13 | 0.11 | 0.08 | 0.10 | 0.08 |
| | T2/(T1 + T2) | | | | | | | |

| | | | | | | | |
|---|---|---|---|---|---|---|---|
| Primary particle diameter (nm) | 105 | 100 | 95 | 110 | 90 | 140 | 85 |
| Aspect ratio of pigment (major-axis | 1.7 | 1.2 | 1.2 | 1.7 | 1.0 | 1.8 | 1.2 |
| particle diameter/minor-axis particle | | | | | | | |
| diameter) | | | | | | | |

TABLE 2-3

| Pigment composition No. | | 15 | 16 | 17 | 18 | 19 | 20 |
|---|---|---|---|---|---|---|---|
| Pigment-kneaded product No. | | 15 | 16 | 17 | 18 | 19 | 20 |
| Drying | Dryer | Thermostat | Heat | Heat | Heat | Heat | Heat |
| condition | | chamber | transfer- | transfer- | transfer- | transfer- | transfer- |
| | | | type | type | type | type | type |
| | | | dryer | dryer | dryer | dryer | dryer |
| | Temperature (° C.) | 60 | 100 | 135 | 100 | 100 | 100 |
| Temperature in kneading minus | | 45 | 10 | −5 | 8 | 0 | 30 |
| temperature in drying (° C.) | | | | | | | |
| X-ray | Peak intensity T1 (diffraction | 1.20 | 1.20 | 1.20 | 1.20 | 1.10 | 1.20 |
| diffraction | angle 2θ = 5.9° ± 0.2°) | | | | | | |
| | Peak intensity T2 (diffraction | 0.16 | 0.12 | 0.18 | 0.18 | 0.25 | 0.12 |
| | angle 2θ = 6.4° ± 0.2°) | | | | | | |
| | Peak intensity ratio | 0.12 | 0.09 | 0.13 | 0.13 | 0.19 | 0.09 |
| | T2/(T1 + T2) | | | | | | |

| | | | | | | |
|---|---|---|---|---|---|---|
| Primary particle diameter (nm) | 145 | 95 | 110 | 95 | 90 | 110 |
| Aspect ratio of pigment (major-axis particle | 1.7 | 1.4 | 1.2 | 1.4 | 1.6 | 1.2 |
| diameter/minor-axis particle diameter) | | | | | | |

TABLE 2-4

| Pigment composition No. | | 21 | 22 | 23 | 24 | 25 | 26 |
|---|---|---|---|---|---|---|---|
| Pigment-kneaded product No. | | 21 | 22 | 23 | 24 | 25 | 26 |
| Drying | Dryer | Heat | Heat | Heat | Thermostat | Thermostat | Heat |
| condition | | transfer- | transfer- | transfer- | chamber | chamber | transfer- |
| | | type | type | type | | | type |
| | | dryer | dryer | dryer | | | dryer |
| | Temperature (° C.) | 100 | 100 | 100 | 80 | 80 | 100 |
| Temperature in kneading minus | | 10 | 10 | 10 | 10 | 5 | 10 |
| temperature in drying (° C.) | | | | | | | |
| X-ray | Peak intensity T1 (diffraction | 1.20 | 1.30 | 1.20 | 1.10 | 1.10 | 1.20 |
| diffraction | angle 2θ = 5.9° ± 0.2°) | | | | | | |
| | Peak intensity T2 (diffraction | 0.16 | 0.12 | 0.12 | 0.2 | 0.25 | 0.13 |
| | angle 2θ = 6.4° ± 0.2°) | | | | | | |
| | Peak intensity ratio | 0.12 | 0.08 | 0.09 | 0.15 | 0.19 | 0.10 |
| | T2/(T1 + T2) | | | | | | |

| | | | | | | |
|---|---|---|---|---|---|---|
| Primary particle diameter (nm) | 150 | 80 | 95 | 85 | 85 | 95 |
| Aspect ratio of pigment (major-axis particle | 1.7 | 1.2 | 1.4 | 1.8 | 1.8 | 1.4 |
| diameter/minor-axis particle diameter) | | | | | | |

TABLE 2-5

| Pigment composition No. | | 27 | 28 | 29 | 30 | 31 | 32 |
|---|---|---|---|---|---|---|---|
| Pigment-kneaded product No. | | 27 | 28 | 29 | 30 | 25 | 25 |
| Drying | Dryer | Heat | Heat | Thermostat | Thermostat | Thermostat | Heat |
| condition | | transfer- | transfer- | chamber | chamber | chamber | transfer- |
| | | type | type | | | | type |
| | | dryer | dryer | | | | dryer |
| | Temperature (° C.) | 100 | 100 | 60 | 60 | 95 | 100 |
| Temperature in kneading minus | | 10 | 10 | 25 | 35 | −10 | −15 |
| temperature in drying (° C.) | | | | | | | |
| X-ray | Peak intensity T1 (diffraction | 1.20 | 1.20 | 1.20 | 1.20 | 1.10 | 1.10 |
| diffraction | angle 2θ = 5.9° ± 0.2°) | | | | | | |
| | Peak intensity T2 (diffraction | 0.13 | 0.12 | 0.26 | 0.35 | 0.30 | 0.36 |
| | angle 2θ = 6.4° ± 0.2°) | | | | | | |
| | Peak intensity ratio | 0.10 | 0.09 | 0.18 | 0.23 | 0.21 | 0.25 |
| | T2/(T1 + T2) | | | | | | |

| | | | | | | |
|---|---|---|---|---|---|---|
| Primary particle diameter (nm) | 95 | 95 | 170 | 200 | 85 | 85 |
| Aspect ratio of pigment (major-axis particle | 1.4 | 1.4 | 1.8 | 2.0 | 1.8 | 1.8 |
| diameter/minor-axis particle diameter) | | | | | | |

### <Synthesis of Resin>

Resins 1 and 2 each serving as a water-soluble random copolymer to be used as a resin dispersant in a pigment dispersion to be described later were each synthesized in accordance with the following procedure. 200.0 Parts of isopropanol was loaded into a flask including a stirring device, a nitrogen-introducing tube, a reflux condenser, and a temperature gauge, and then, under a nitrogen atmosphere, its temperature was increased to 85° C. while isopropanol was stirred. A mixture of monomers whose kinds and amounts were shown in Table 3, and a polymerization initiator were each dropped into the flask over 2 hours while a temperature was maintained at 80° C. A mixture was stirred for 4 hours while an internal temperature was maintained at 80° C. Thus, a resin was synthesized. 0.9 Equivalent of potassium hydroxide with respect to the acid value of the resin and an appropriate amount of ion-exchanged water were added to the resin, and then isopropanol was removed under reduced pressure. Thus, resin aqueous solutions 1 and 2 that were alkali aqueous solutions of resins 1 and 2 were obtained. With regard to the contents of the resins (solid content) in the resin aqueous solutions, the content in each of the resin aqueous solutions 1 and 2 was 20.0%. A value of a weight-average molecular weight based on standard polystyrene measured for each of the resins by GPC, and an acid value measured therefor with a potentiometric titrator using a potassium hydroxide-methanol titrant are shown in Table 3. The meanings of abbreviations in Table 3 are described below.
St: styrene
nBA: n-butyl acrylate
AA: acrylic acid

Polymerization initiator: solution obtained by dissolving 5.0 parts of a product available under the product name “Perkadox L-W75 (LS)” (manufactured by Kayaku Akzo Corporation, dibenzoyl peroxide, purity: 75%) in 10.0 parts of isopropanol.

TABLE 3

| | | | | | Characteristic | |
|---|---|---|---|---|---|---|
| | | | | | Weight- | |
| | | | | Polymerization | average | |
| | Monomer (part(s)) | | | initiator | molecular | Acid value |
| Resin | St | nBA | AA | (part(s)) | weight | (mgKOH/g) |
| 1 | 60.0 | 20.0 | 20.0 | 5.0 | 9,000 | 140 |
| 2 | 60.0 | 20.0 | 15.0 | 2.5 | 15,000 | 105 |

### <Preparation of Pigment Dispersion>

A quinacridone solid solution pigment and a resin aqueous solution whose kinds and amounts were shown in Table 4, and ion-exchanged water whose amount was shown in Table 4 were mixed, and a dispersing step was performed under a condition 1 or a condition 2 described below. After that, an appropriate amount of ion-exchanged water was added to provide pigment dispersions 1 to 34 each having a pigment content of 20.0%.

### (Condition 1)

In the dispersing step under the condition 1, the respective components were mixed, and the mixture was subjected to dispersion treatment with a high-pressure homogenizer (product name: “STAR BURST”, manufactured by Sugino Machine Limited) at a treatment pressure of 200 MPa.

### (Condition 2)

In the dispersing step under the condition 2, the respective components were mixed, and the mixture was loaded into a batch-type vertical sand mill (manufactured by Aimex Co., Ltd.). 150.0 Parts of zirconia beads each having a diameter of 0.3 mm were loaded into the sand mill, and the mixture was subjected to dispersion treatment for 5 hours while being cooled with water.

TABLE 4

| | Component | | | | | |
|---|---|---|---|---|---|---|
| | | | | | Ion- | |
| | Pigment | | Resin aqueous | | exchanged | |
| | composition | | solution | | water | Dispersing |
| Pigment | Kind | | Kind | Amount | Amount | step |
| dispersion | (No.) | Part(s) | (No.) | (part(s)) | (part(s)) | Condition |
| 1 | 1 | 20.0 | 1 | 30.0 | 50.0 | 1 |
| 2 | 2 | 20.0 | 1 | 30.0 | 50.0 | 1 |
| 3 | 3 | 20.0 | 1 | 30.0 | 50.0 | 1 |
| 4 | 4 | 20.0 | 1 | 30.0 | 50.0 | 1 |
| 5 | 5 | 20.0 | 1 | 30.0 | 50.0 | 1 |
| 6 | 6 | 20.0 | 1 | 30.0 | 50.0 | 1 |
| 7 | 7 | 20.0 | 1 | 30.0 | 50.0 | 1 |
| 8 | 8 | 20.0 | 1 | 30.0 | 50.0 | 1 |
| 9 | 9 | 20.0 | 1 | 30.0 | 50.0 | 1 |
| 10 | 10 | 20.0 | 1 | 30.0 | 50.0 | 1 |
| 11 | 11 | 20.0 | 1 | 30.0 | 50.0 | 1 |
| 12 | 12 | 20.0 | 1 | 30.0 | 50.0 | 1 |
| 13 | 13 | 20.0 | 1 | 15.0 | 65.0 | 1 |
| 14 | 14 | 20.0 | 1 | 30.0 | 50.0 | 1 |
| 15 | 15 | 20.0 | 1 | 30.0 | 50.0 | 1 |
| 16 | 16 | 20.0 | 1 | 30.0 | 50.0 | 1 |
| 17 | 17 | 20.0 | 1 | 30.0 | 50.0 | 1 |
| 18 | 18 | 20.0 | 1 | 30.0 | 50.0 | 1 |
| 19 | 19 | 20.0 | 1 | 30.0 | 50.0 | 1 |
| 20 | 20 | 20.0 | 1 | 30.0 | 50.0 | 1 |
| 21 | 21 | 20.0 | 1 | 30.0 | 50.0 | 1 |
| 22 | 22 | 20.0 | 1 | 30.0 | 50.0 | 1 |
| 23 | 23 | 20.0 | 1 | 30.0 | 50.0 | 1 |
| 24 | 24 | 20.0 | 1 | 30.0 | 50.0 | 1 |
| 25 | 25 | 20.0 | 1 | 30.0 | 50.0 | 1 |
| 26 | 16 | 20.0 | 1 | 30.0 | 50.0 | 2 |
| 27 | 16 | 20.0 | 2 | 15.0 | 65.0 | 1 |
| 28 | 26 | 20.0 | 1 | 30.0 | 50.0 | 1 |
| 29 | 27 | 20.0 | 1 | 30.0 | 50.0 | 1 |
| 30 | 28 | 20.0 | 1 | 30.0 | 50.0 | 1 |
| 31 | 29 | 20.0 | 1 | 30.0 | 50.0 | 1 |
| 32 | 30 | 20.0 | 1 | 30.0 | 50.0 | 1 |
| 33 | 31 | 20.0 | 1 | 30.0 | 50.0 | 1 |
| 34 | 32 | 20.0 | 1 | 30.0 | 50.0 | 1 |

### <Preparation of Ink>

Respective components (unit: mass %) shown in the middle section of each of Tables 5 (Table 5-1 to Table 5-5) were mixed, and were sufficiently stirred to be dispersed, followed by filtration with a microfilter having a pore size of 3.0 μm (manufactured by FUJIFILM Corporation) under pressure. Thus, inks 1 to 34 were prepared.

### EVALUATION

The inks 1 to 34 were each loaded into an ink cartridge, and the cartridge was set in an inkjet recording apparatus (product name: “PIXUS PRO-10”, manufactured by Canon Inc.) mounted with a recording head that ejected the ink with thermal energy. The resolution of the above-mentioned inkjet recording apparatus is 2,400 dpi×1,200 dpi. Then, an image recorded under the following condition is defined as having a recording duty of 100%: one ink droplet having a mass of 30.4 ng is applied to a unit region measuring 1/600 inch by 1/600 inch. A solid image having a recording duty of 140% was recorded on plain paper (product name: “Office 70”, manufactured by Canon Inc.) serving as a recording medium with the above-mentioned inkjet recording apparatus. Then, evaluations described below were performed. Results are shown in the lower sections of Tables 5 (Tables 5-1 to 5-5).

### (Clarity)

A brightness in each of the solid images obtained in the foregoing was measured with a fluorescent spectrodensitometer (product name: “FD-7”, manufactured by Konica Minolta, Inc.) under the conditions of a D50 light source and a viewing angle of 2°, and a clarity of an image was evaluated in accordance with the following evaluation criteria. In the following evaluation criteria, levels “AA” and “A” were defined as acceptable levels, and levels “B” and “C” were defined as unacceptable levels.
AA: The brightness was 47.5 or more.
A: The brightness was 46.9 or more and less than 47.5.
B: The brightness was 46.5 or more and less than 46.9.
C: The brightness was less than 46.5.

In each of Reference Examples 1 to 3, the value of the ratio “T2/(T1+T2)” was more than 0.13, and hence images were evaluated as “B”.

### (Storage Stability)

The viscosity of each of the inks obtained in the foregoing before the storage of the inks was measured. The inks whose viscosity had been measured was loaded into a closed container and was placed in a thermostat chamber at 70° C. for 2 weeks. After that, the temperature of the inks was returned to 25° C., and the viscosity of each of the inks after its storage was measured. The viscosities of the inks were measured with an E-type viscometer (product name: “RE-80L”, manufactured by Toki Sangyo Co., Ltd.). Then, the viscosity ratio of each of the inks was calculated based on the equation “viscosity ratio”=“viscosity of ink after storage”/“viscosity of ink before storage”, and the storage stability of the ink was evaluated in accordance with the following evaluation criteria. In the following evaluation criteria, levels “A” and “B” were defined as acceptable levels, and a level “C” was defined as an unacceptable level.
A: The viscosity ratio was 1.1 or less.
B: The viscosity ratio was more than 1.1 and 1.2 or less.
C: The viscosity ratio was more than 1.2.

TABLE 5-1

| | | Example | | | | | | | | |
|---|---|---|---|---|---|---|---|---|---|---|
| | | 1 | 2 | 3 | 4 | 5 | 6 | 7 | 8 | 9 |
| Ink No. | | 1 | 2 | 3 | 4 | 5 | 6 | 7 | 8 | 9 |
| Pigment dispersion No. | | 1 | 2 | 3 | 4 | 5 | 6 | 7 | 8 | 9 |
| Component | Pigment dispersion | 25.0 | 25.0 | 25.0 | 25.0 | 25.0 | 25.0 | 25.0 | 25.0 | 25.0 |
| | Glycerin | 5.0 | 5.0 | 5.0 | 5.0 | 5.0 | 5.0 | 5.0 | 5.0 | 5.0 |
| | Triethylene glycol | 0.0 | 0.0 | 0.0 | 0.0 | 0.0 | 0.0 | 0.0 | 0.0 | 0.0 |
| | ACETYLENOL | 0.0 | 0.0 | 0.0 | 0.0 | 0.0 | 0.0 | 0.0 | 0.0 | 0.0 |
| | E100 | | | | | | | | | |
| | Ion-exchanged | 70.0 | 70.0 | 70.0 | 70.0 | 70.0 | 70.0 | 70.0 | 70.0 | 70.0 |
| | water | | | | | | | | | |
| Evaluation | Clarity | AA | AA | AA | AA | AA | AA | AA | AA | AA |
| | Storage stability | A | A | A | A | A | A | A | A | A |

TABLE 5-2

| | | Example | | | | | | | | |
|---|---|---|---|---|---|---|---|---|---|---|
| | | 10 | 11 | 12 | 13 | 14 | 15 | 16 | 17 | 18 |
| Ink No. | | 10 | 11 | 12 | 13 | 14 | 15 | 16 | 17 | 18 |
| Pigment dispersion No. | | 10 | 11 | 12 | 13 | 14 | 15 | 16 | 17 | 18 |
| Component | Pigment dispersion | 25.0 | 25.0 | 25.0 | 25.0 | 25.0 | 25.0 | 33.0 | 33.0 | 33.0 |
| | Glycerin | 5.0 | 5.0 | 5.0 | 5.0 | 5.0 | 5.0 | 10.0 | 10.0 | 10.0 |
| | Triethylene glycol | 0.0 | 0.0 | 0.0 | 0.0 | 0.0 | 0.0 | 7.0 | 7.0 | 7.0 |
| | ACETYLENOL | 0.0 | 0.0 | 0.0 | 0.0 | 0.0 | 0.0 | 0.1 | 0.1 | 0.1 |
| | E100 | | | | | | | | | |
| | Ion-exchanged | 70.0 | 70.0 | 70.0 | 70.0 | 70.0 | 70.0 | 49.9 | 49.9 | 49.9 |
| | water | | | | | | | | | |
| Evaluation | Clarity | A | AA | A | A | A | A | AA | A | A |
| | Storage stability | A | A | A | A | A | A | A | A | A |

TABLE 5-3

| | | Example | | | | | | | | |
|---|---|---|---|---|---|---|---|---|---|---|
| | | 19 | 20 | 21 | 22 | 23 | 24 | 25 | 26 | 27 |
| Ink No. | | 20 | 21 | 22 | 23 | 26 | 27 | 28 | 29 | 30 |
| Pigment dispersion No. | | 20 | 21 | 22 | 23 | 26 | 27 | 28 | 29 | 30 |
| Component | Pigment dispersion | 33.0 | 33.0 | 33.0 | 33.0 | 33.0 | 33.0 | 33.0 | 33.0 | 33.0 |
| | Glycerin | 10.0 | 10.0 | 10.0 | 10.0 | 10.0 | 10.0 | 10.0 | 10.0 | 10.0 |
| | Triethylene glycol | 7.0 | 7.0 | 7.0 | 7.0 | 7.0 | 7.0 | 7.0 | 7.0 | 7.0 |
| | ACETYLENOL | 0.1 | 0.1 | 0.1 | 0.1 | 0.1 | 0.1 | 0.1 | 0.1 | 0.1 |
| | E100 | | | | | | | | | |
| | Ion-exchanged | 49.9 | 49.9 | 49.9 | 49.9 | 49.9 | 49.9 | 49.9 | 49.9 | 49.9 |
| | water | | | | | | | | | |
| Evaluation | Clarity | AA | A | A | AA | AA | AA | AA | AA | AA |
| | Storage stability | A | A | A | A | A | A | A | A | A |

TABLE 5-4

Reference Example

| | | 1 | 2 | 3 |
|---|---|---|---|---|
| Ink No. | | 19 | 24 | 25 |
| Pigment dispersion No. | | 19 | 24 | 25 |
| Component | Pigment dispersion | 33.0 | 33.0 | 33.0 |
| | Glycerin | 10.0 | 10.0 | 10.0 |
| | Triethylene glycol | 7.0 | 7.0 | 7.0 |
| | ACETYLENOL E100 | 0.1 | 0.1 | 0.1 |
| | Ion-exchanged water | 49.9 | 49.9 | 49.9 |
| Evaluation | Clarity | B | B | B |
| | Storage stability | A | B | B |

TABLE 5-5

| | | Comparative Example | | | |
|---|---|---|---|---|---|
| | | 1 | 2 | 3 | 4 |
| Ink No. | | 31 | 32 | 33 | 34 |
| Pigment dispersion No. | | 31 | 32 | 33 | 34 |
| Component | Pigment dispersion | 25.0 | 25.0 | 33.0 | 33.0 |
| | Glycerin | 5.0 | 5.0 | 10.0 | 10.0 |
| | Triethylene glycol | 0.0 | 0.0 | 7.0 | 7.0 |
| | ACETYLENOL E100 | 0.0 | 0.0 | 0.1 | 0.1 |
| | Ion-exchanged water | 70.0 | 70.0 | 49.9 | 49.9 |
| Evaluation | Clarity | B | C | C | C |
| | Storage stability | B | C | C | B |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-028413, filed Feb. 27, 2023, Japanese Patent Application No. 2023-028412, filed Feb. 27, 2023, and Japanese Patent Application No. 2024-025583, filed Feb. 22, 2024, which are hereby incorporated by reference herein in their entirety.

What is claimed is:

1. A quinacridone solid solution pigment comprising at least two kinds of quinacridone-based pigments including unsubstituted quinacridone and 2,9-dialkylquinacridone,
wherein when a diffraction peak intensity at a diffraction angle 2θ of 5.9°±0.2° and a diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.

2. The quinacridone solid solution pigment according to claim 1, wherein a mass proportion of the unsubstituted quinacridone to the 2,9-dialkylquinacridone is from 80:20 to 60:40.

3. The quinacridone solid solution pigment according to claim 1, wherein the quinacridone solid solution pigment has an arithmetic average particle diameter (volume average) of 90 nm or more and 140 nm or less.

4. The quinacridone solid solution pigment according to claim 1, wherein the quinacridone solid solution pigment has an aspect ratio (major-axis particle diameter/minor-axis particle diameter) of 1.1 or more and 1.7 or less.

5. The quinacridone solid solution pigment according to claim 1, wherein the quinacridone solid solution pigment is used in an inkjet ink.

6. A pigment dispersion comprising:
a dispersion medium; and
a pigment dispersed in the dispersion medium,
wherein the pigment is a quinacridone solid solution pigment including at least two kinds of quinacridone-based pigments including unsubstituted quinacridone and 2,9-dialkylquinacridone, and
wherein when a diffraction peak intensity at a diffraction angle 2θ of 5.9°±0.2° and a diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.

7. A method of producing a quinacridone solid solution pigment comprising a kneading step of kneading a mixture containing at least two kinds of quinacridone-based pigments including unsubstituted quinacridone and 2,9-dialkylquinacridone, a water-soluble inorganic salt, and a water-soluble organic solvent with a kneading apparatus to provide a pigment-kneaded product containing the quinacridone solid solution pigment,
wherein the kneading step includes kneading the mixture with a kneading energy of 15 kWh/kg or more per unit mass (kg) of the quinacridone-based pigments.

8. The method of producing a quinacridone solid solution pigment according to claim 7, wherein a set temperature of the kneading apparatus is 100° C. or more when kneading the mixture in the kneading step.

9. The method of producing a quinacridone solid solution pigment according to claim 7, further comprising a moisture-adjusting step of heating a liquid composition containing the quinacridone solid solution pigment obtained in the kneading step and water at a temperature equal to or less than a set temperature of the kneading apparatus in the kneading step to evaporate moisture thereof, to thereby adjust a moisture content of the liquid composition.

10. The method of producing a quinacridone solid solution pigment according to claim 9, wherein a temperature in the moisture-adjusting step is lower than the set temperature in the kneading step by 10° C. or more.

11. The method of producing a quinacridone solid solution pigment according to claim 8, wherein the kneading step includes kneading the mixture under such a condition that the set temperature of the kneading apparatus is 100° C. or more, and that a temperature of a kneaded product in a kneading process becomes 100° C. or more.

12. The method of producing a quinacridone solid solution pigment according to claim 9, wherein the moisture-adjusting step includes bringing the liquid composition into contact with a heat source to adjust the moisture content of the liquid composition.

13. A method of producing a pigment dispersion comprising:
a kneading step of kneading a mixture containing at least two kinds of quinacridone-based pigments including unsubstituted quinacridone and 2,9-dialkylquinacridone, a water-soluble inorganic salt, and a water-soluble organic solvent with a kneading apparatus to provide a pigment-kneaded product containing a quinacridone solid solution pigment; and
a dispersing step of dispersing the quinacridone solid solution pigment in a dispersion medium after removing the water-soluble inorganic salt and the water-soluble organic solvent from the pigment-kneaded product,
wherein the kneading step includes kneading the mixture with a kneading energy of 15 kWh/kg or more per unit mass (kg) of the quinacridone-based pigments.

14. An ink comprising a quinacridone solid solution pigment,
wherein the quinacridone solid solution pigment includes at least two kinds of quinacridone-based pigments including unsubstituted quinacridone and 2,9-dialkylquinacridone, and
wherein when a diffraction peak intensity at a diffraction angle 2θ of 5.9°±0.2° and a diffraction peak intensity at a diffraction angle 2θ of 6.4°±0.2°, which are obtained by X-ray diffractometry, are represented by T1 and T2, respectively, T1 and T2 satisfy T2/(T1+T2)≤0.13.
